(19) United States
(12) Patent Application Publication
(10) Pub. No.: US 2024/0414398 A1
(43) Pub. Date: Dec. 12, 2024

(54) SYSTEM AND METHOD FOR STREAM ANALYSIS

(71) Applicant: 17LIVE Japan Inc., Tokyo (JP)

(72) Inventors: Yung-Chi HSU, Taipei City (TW); Chi-Wei LIN, Taipei City (TW); Shao-Tang CHIEN, Taipei City (TW); Wei-Hsiang HUNG, Taipei City (TW)

(21) Appl. No.: 18/517,603

(22) Filed: Nov. 22, 2023

(30) Foreign Application Priority Data
Jun. 9, 2023 (JP) 2023-095326

(51) Int. Cl. H04N 21/442

(52) U.S. Cl. CPC H04N 21/44222

(57) ABSTRACT

The present disclosure relates to a system and a method for stream analysis. The method includes: obtaining a first set of interaction parameters of a first stream performed by a distributor; generating a first set of performance scores for the first stream according to the first set of interaction parameters; obtaining a first set of content tags of the first stream; and associating the first set of performance scores with the first set of content tags.

### CROSS-REFERENCE TO RELATED APPLICATIONS

This application is based on and claims the benefit of priority from Japanese Patent Application Serial No. 2023-095326 (filed on Jun. 9, 2023), the contents of which are hereby incorporated by reference in its entirety.

### TECHNICAL FIELD

The present disclosure relates to stream analysis in the streaming field.

### BACKGROUND

Real time interaction on the Internet, such as live streaming service, has become popular in our daily life. There are various platforms or providers providing the service of live streaming, and the competition is fierce. It is important for a platform to provide its users their desired services.

China patent application publication CN113747188A discloses a monitoring system and method for video live broadcast quality.

### SUMMARY

A method according to one embodiment of the present disclosure is a method for stream analysis being executed by one or a plurality of computers, and includes: obtaining a first set of interaction parameters of a first stream performed by a distributor; generating a first set of performance scores for the first stream according to the first set of interaction parameters; obtaining a first set of content tags of the first stream; and associating the first set of performance scores with the first set of content tags.

A method according to one embodiment of the present disclosure is a method for stream analysis being executed by one or a plurality of computers, and includes: obtaining a first set of interaction parameters of a first stream performed by a distributor; generating a first set of performance scores for the first stream according to the first set of interaction parameters; obtaining a second set of interaction parameters of a second stream performed by the distributor; generating a second set of performance scores for the second stream according to the second set of interaction parameters; determining the second stream to have a shorter poor performance time period than the first stream; and increasing a recommending priority for the distributor. The poor performance time period corresponds to a performance score lower than a poor performance score threshold or corresponds to a performance score dropping rate greater than a performance score dropping rate threshold.

A system according to one embodiment of the present disclosure is a system for stream analysis that includes one or a plurality of processors, and the one or plurality of computer processors execute a machine-readable instruction to perform: obtaining a first set of interaction parameters of a first stream performed by a distributor; generating a first set of performance scores for the first stream according to the first set of interaction parameters; obtaining a first set of content tags of the first stream; and associating the first set of performance scores with the first set of content tags.

### BRIEF DESCRIPTION OF THE DRAWINGS

FIG. 1 shows a schematic configuration of a live streaming system 1 according to some embodiments of the present disclosure.

FIG. 2 is a block diagram showing functions and configuration of the user terminal 30 of FIG. 1 according to some embodiments of the present disclosure.

FIG. 3 shows a block diagram illustrating functions and configuration of the server of FIG. 1 according to some embodiments of the present disclosure.

FIG. 4 is a data structure diagram of an example of the stream DB 310 of FIG. 3.

FIG. 5 is a data structure diagram showing an example of the user DB 312 of FIG. 3.

FIG. 6 is a data structure diagram showing an example of the gift DB 314 of FIG. 3.

FIG. 7 is a data structure diagram of an example of the interaction parameter DB 350 of FIG. 3.

FIG. 8 is a data structure diagram of an example of the performance score DB 352 of FIG. 3.

FIG. 9 is a data structure diagram of an example of the content tag DB 354 of FIG. 3.

FIG. 10 shows an example of associating or correlating performance scores with content tags for a stream.

FIG. 11 shows a data structure diagram of an example of the analysis result DB 356 of FIG. 3.

FIG. 12 shows an example of content suggestion during live streaming.

FIG. 13 shows an exemplary flow chart illustrating a method according to some embodiments of the present disclosure.

FIG. 14 shows an example of input and output of the ML model 370.

FIG. 15 is a block diagram showing an example of a hardware configuration of the information processing device according to some embodiments of the present disclosure.

### DETAILED DESCRIPTION

Hereinafter, the identical or similar components, members, procedures or signals shown in each drawing are referred to with like numerals in all the drawings, and thereby an overlapping description is appropriately omitted. Additionally, a portion of a member which is not important in the explanation of each drawing is omitted.

It is desirable for a content platform to provide tools to its content distributors (or streamers, or livestreamers) that could help the content distributors to review their past performance and to perform better in the future. The present disclosure provides systems or methods to help distributors analyze their own stream archives, so that the distributors can do better in the next live streaming.

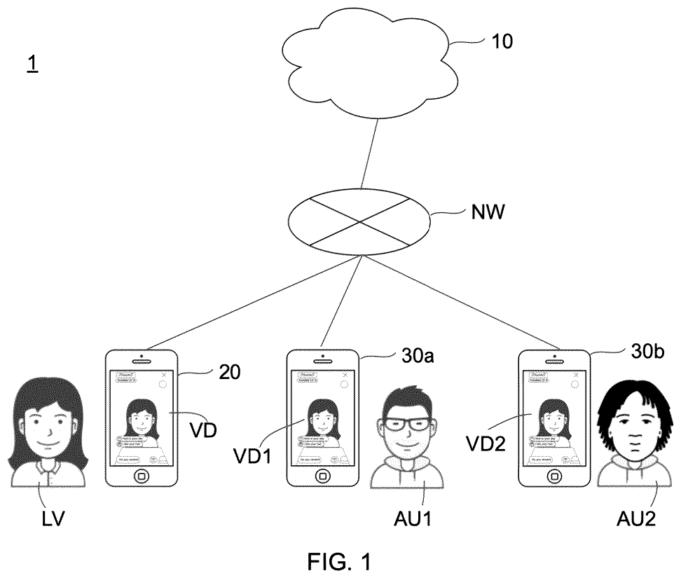

FIG. 1 shows a schematic configuration of a live streaming system 1 according to some embodiments of the present disclosure. The live streaming system 1 provides a live streaming service for the streaming streamer (could be referred to as liver, anchor, distributor, or livestreamer) LV and viewer (could be referred to as audience) AU (AU1, AU2 . . . ) to interact or communicate in real time. As shown in FIG. 1, the live streaming system 1 includes a server 10, a user terminal 20 and user terminals 30 (30a, 30b . . . ). In some embodiments, the streamers and viewers may be collectively referred to as users. The server 10 may include one or a plurality of information processing devices connected to a network NW. The user terminal 20 and 30 may be, for example, mobile terminal devices such as smartphones, tablets, laptop PCs, recorders, portable gaming devices, and wearable devices, or may be stationary devices such as desktop PCs. The server 10, the user terminal 20 and the user terminal 30 are interconnected so as to be able to communicate with each other over the various wired or wireless networks NW.

The live streaming system 1 involves the distributor LV, the viewers AU, and an administrator (or an APP provider, not shown) who manages the server 10. The distributor LV is a person who broadcasts contents in real time by recording the contents with his/her user terminal 20 and uploading them directly or indirectly to the server 10. Examples of the contents may include the distributor's own songs, talks, performances, gameplays, and any other contents. The administrator provides a platform for live-streaming contents on the server 10, and also mediates or manages real-time interactions between the distributor LV and the viewers AU. The viewer AU accesses the platform at his/her user terminal 30 to select and view a desired content. During live-streaming of the selected content, the viewer AU performs operations to comment, cheer, or send gifts via the user terminal 30. The distributor LV who is delivering the content may respond to such comments, cheers, or gifts. The response is transmitted to the viewer AU via video and/or audio, thereby establishing an interactive communication.

The term “live-streaming” may mean a mode of data transmission that allows a content recorded at the user terminal 20 of the distributor LV to be played or viewed at the user terminals 30 of the viewers AU substantially in real time, or it may mean a live broadcast realized by such a mode of transmission. The live-streaming may be achieved using existing live delivery technologies such as HTTP Live Streaming, Common Media Application Format, Web Real-Time Communications, Real-Time Messaging Protocol and MPEG DASH. Live-streaming includes a transmission mode in which the viewers AU can view a content with a specified delay simultaneously with the recording of the content by the distributor LV. As for the length of the delay, it may be acceptable for a delay with which interaction between the distributor LV and the viewers AU can be established. Note that the live-streaming is distinguished from so-called on-demand type transmission, in which the entire recorded data of the content is once stored on the server, and the server provides the data to a user at any subsequent time upon request from the user.

The term “video data” herein refers to data that includes image data (also referred to as moving image data) generated using an image capturing function of the user terminals 20 or 30, and audio data generated using an audio input function of the user terminals 20 or 30. Video data is reproduced in the user terminals 20 and 30, so that the users can view contents. In some embodiments, it is assumed that between video data generation at the distributor's user terminal and video data reproduction at the viewer's user terminal, processing is performed onto the video data to change its format, size, or specifications of the data, such as compression, decompression, encoding, decoding, or transcoding. However, the content (e.g., video images and audios) represented by the video data before and after such processing does not substantially change, so that the video data after such processing is herein described as the same as the video data before such processing. In other words, when video data is generated at the distributor's user terminal and then played back at the viewer's user terminal via the server 10, the video data generated at the distributor's user terminal, the video data that passes through the server 10, and the video data received and reproduced at the viewer's user terminal are all the same video data.

In the example in FIG. 1, the distributor LV provides the live streaming data. The user terminal 20 of the distributor LV generates the streaming data by recording images and sounds of the distributor LV, and the generated data is transmitted to the server 10 over the network NW. At the same time, the user terminal 20 displays a recorded video image VD of the distributor LV on the display of the user terminal 20 to allow the distributor LV to check the live streaming contents currently performed.

The user terminals 30a and 30b of the viewers AU1 and AU2 respectively, who have requested the platform to view the live streaming of the distributor LV, receive video data related to the live streaming (may also be herein referred to as “live-streaming video data”) over the network NW and reproduce the received video data to display video images VD1 and VD2 on the displays and output audio through the speakers. The video images VD1 and VD2 displayed at the user terminals 30a and 30b, respectively, are substantially the same as the video image VD captured by the user terminal 20 of the distributor LV, and the audio outputted at the user terminals 30a and 30b is substantially the same as the audio recorded by the user terminal 20 of the distributor LV.

Recording of the images and sounds at the user terminal 20 of the distributor LV and reproduction of the video data at the user terminals 30a and 30b of the viewers AU1 and AU2 are performed substantially simultaneously. Once the viewer AU1 types a comment about the contents provided by the distributor LV on the user terminal 30a, the server 10 displays the comment on the user terminal 20 of the distributor LV in real time and also displays the comment on the user terminals 30a and 30b of the viewers AU1 and AU2, respectively. When the distributor LV reads the comment and develops his/her talk to cover and respond to the comment, the video and sound of the talk are displayed on the user terminals 30a and 30b of the viewers AU1 and AU2, respectively. This interactive action is recognized as the establishment of a conversation between the distributor LV and the viewer AU1. In this way, the live streaming system 1 realizes the live streaming that enables interactive communication, not one-way communication.

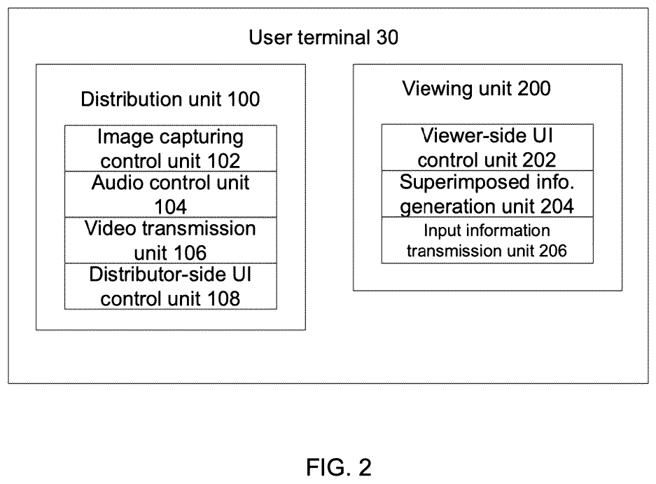

FIG. 2 is a block diagram showing functions and configuration of the user terminal 30 of FIG. 1 according to some embodiments of the present disclosure. The user terminal 20 has the same or similar functions and configuration as the user terminal 30. Each block in FIG. 2 and the subsequent block diagrams may be realized by elements such as a computer CPU or a mechanical device in terms of hardware, and can be realized by a computer program or the like in terms of software. Functional blocks could be realized by cooperative operation between these elements. Therefore, it is understood by those skilled in the art that these functional blocks can be realized in various forms by combining hardware and software.

The distributor LV and the viewers AU may download and install a live streaming application program (hereinafter referred to as a live streaming application) to the user terminals 20 and 30 from a download site over the network NW. Alternatively, the live streaming application may be pre-installed on the user terminals 20 and 30. When the live streaming application is executed on the user terminals 20 and 30, the user terminals 20 and 30 communicate with the server 10 over the network NW to implement or execute various functions. Hereinafter, the functions implemented by the user terminals 20 and 30 (processors such as CPUs) in which the live streaming application is run will be described as functions of the user terminals 20 and 30. These functions are realized in practice by the live streaming application on the user terminals 20 and 30. In some embodiments, these functions may be realized by a computer program that is written in a programming language such as HTML (HyperText Markup Language), transmitted from the server 10 to web browsers of the user terminals 20 and 30 over the network NW, and executed by the web browsers.

The user terminal 30 includes a distribution unit 100 and a viewing unit 200. The distribution unit 100 generates video data in which the user's (or the user side's) image and sound are recorded, and provides the video data to the server 10. The viewing unit 200 receives video data from the server 10 to reproduce the video data. The user activates the distribution unit 100 when the user performs live streaming, and activates the viewing unit 200 when the user views a video. The user terminal in which the distribution unit 100 is activated is the distributor's terminal, i.e., the user terminal that generates the video data. The user terminal in which the viewing unit 200 is activated is the viewer's terminal, i.e., the user terminal in which the video data is reproduced and played.

The distribution unit 100 includes an image capturing control unit 102, an audio control unit 104, a video transmission unit 106, and a distribution-side UI control unit 108. The image capturing control unit 102 is connected to a camera (not shown in FIG. 2) and controls image capturing performed by the camera. The image capturing control unit 102 obtains image data from the camera. The audio control unit 104 is connected to a microphone (not shown in FIG. 2) and controls audio input from the microphone. The audio control unit 104 obtains audio data through the microphone. The video transmission unit 106 transmits video data including the image data obtained by the image capturing control unit 102 and the audio data obtained by the audio control unit 104 to the server 10 over the network NW. The video data is transmitted by the video transmission unit 106 in real time. That is, the generation of the video data by the image capturing control unit 102 and the audio control unit 104, and the transmission of the generated video data by the video transmission unit 106 are performed substantially at the same time. The distribution-side UI control unit 108 controls an UI (user interface) for the distributor. The distribution-side UI control unit 108 may be connected to a display (not shown in FIG. 2), and displays a video on the display by reproducing the video data that is to be transmitted by the video transmission unit 106. The distribution-side UI control unit 108 may display an operation object or an instruction-accepting object on the display, and accepts inputs from the distributor who taps on the object.

The viewing unit 200 includes a viewer-side UI control unit 202, a superimposed information generation unit 204, and an input information transmission unit 206. The viewing unit 200 receives, from the server 10 over the network NW, video data related to the live streaming in which the distributor, the viewer who is the user of the user terminal 30, and other viewers participate. The viewer-side UI control unit 202 controls the UI for the viewers. The viewer-side UI control unit 202 is connected to a display and a speaker (not shown in FIG. 2), and reproduces the received video data to display video images on the display and output audio through the speaker. The state where the image is outputted to the display and the audio is outputted from the speaker can be referred to as “the video data is played”. The viewer-side UI control unit 202 is also connected to input means (not shown in FIG. 2) such as touch panels, keyboards, and displays, and obtains user input via these input means. The superimposed information generation unit 204 superimposes a predetermined frame image on an image generated from the video data from the server 10. The frame image includes various user interface objects (hereinafter simply referred to as “objects”) for accepting inputs from the user, comments entered by the viewers, and/or information obtained from the server 10. The input information transmission unit 206 transmits the user input obtained by the viewer-side UI control unit 202 to the server 10 over the network NW.

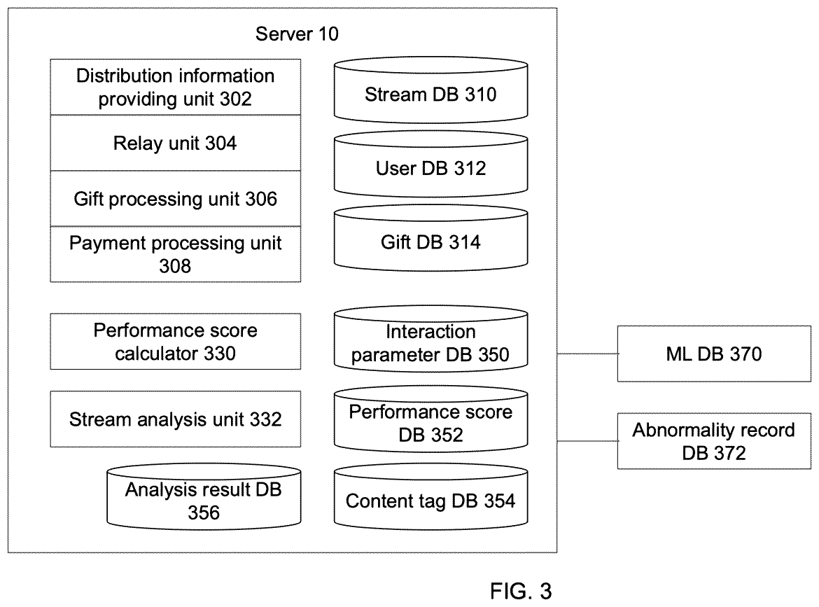

FIG. 3 shows a block diagram illustrating functions and configuration of the server 10 of FIG. 1 according to some embodiments of the present disclosure. The server 10 includes a distribution information providing unit 302, a relay unit 304, a gift processing unit 306, a payment processing unit 308, a stream DB 310, a user DB 312, a gift DB 314, a performance score calculator 330, a stream analysis unit 332, an interaction parameter DB 350, a performance score DB 352, a content tag DB 354, and an analysis result DB 356. The server 10 communicates with a machine learning (ML) DB 370 and an abnormality record DB 372. In some embodiments, the ML DB 370 and/or the abnormality record DB 372 can be implemented within the server 10.

Upon reception of a notification or a request from the user terminal 20 on the distributor side to start a live streaming over the network NW, the distribution information providing unit 302 registers a stream ID for identifying this live streaming and the distributor ID of the distributor who performs the live streaming in the stream DB 310.

When the distribution information providing unit 302 receives a request to provide information about live streams from the viewing unit 200 of the user terminal 30 on the viewer side over the network NW, the distribution information providing unit 302 retrieves or checks currently available live streams from the stream DB 310 and makes a list of the available live streams. The distribution information providing unit 302 transmits the generated list to the requesting user terminal 30 over the network NW. The viewer-side UI control unit 202 of the requesting user terminal 30 generates a live stream selection screen based on the received list and displays it on the display of the user terminal 30.

Once the input information transmission unit 206 of the user terminal 30 receives the viewer's selection result on the live stream selection screen, the input information transmission unit 206 generates a distribution request including the stream ID of the selected live stream, and transmits the request to the server 10 over the network NW. The distribution information providing unit 302 starts providing, to the requesting user terminal 30, the live stream specified by the stream ID included in the received distribution request. The distribution information providing unit 302 updates the stream DB 310 to include the user ID of the viewer of the requesting user terminal 30 into the viewer IDs of (or corresponding to) the stream ID.

The relay unit 304 relays the video data from the distributor-side user terminal 20 to the viewer-side user terminal 30 in the live streaming started by the distribution information providing unit 302. The relay unit 304 receives from the input information transmission unit 206 a signal that represents user input by a viewer during the live streaming or reproduction of the video data. The signal that represents user input may be an object specifying signal for specifying an object displayed on the display of the user terminal 30. The object specifying signal may include the viewer ID of the viewer, the distributor ID of the distributor of the live stream that the viewer watches, and an object ID that identifies the object. When the object is a gift, the object ID is the gift ID. Similarly, the relay unit 304 receives, from the distribution unit 100 of the user terminal 20, a signal that represents user input performed by the distributor during reproduction of the video data (or during the live streaming). The signal could be an object specifying signal.

Alternatively, the signal that represents user input may be a comment input signal including a comment entered by a viewer into the user terminal 30 and the viewer ID of the viewer. Upon reception of the comment input signal, the relay unit 304 transmits the comment and the viewer ID included in the signal to the user terminal 20 of the distributor and the user terminals 30 of other viewers. In these user terminals 20 and 30, the viewer-side UI control unit 202 and the superimposed information generation unit 204 display the received comment on the display in association with the viewer ID also received.

The gift processing unit 306 updates the user DB 312 so as to increase the points of the distributor depending on the points of the gift identified by the gift ID included in the object specifying signal. Specifically, the gift processing unit 306 refers to the gift DB 314 to specify the points to be granted for the gift ID included in the received object specifying signal. The gift processing unit 306 then updates the user DB 312 to add the determined points to the points of (or corresponding to) the distributor ID included in the object specifying signal.

The payment processing unit 308 processes payment of a price of a gift from a viewer in response to reception of the object specifying signal. Specifically, the payment processing unit 308 refers to the gift DB 314 to specify the price points of the gift identified by the gift ID included in the object specifying signal. The payment processing unit 308 then updates the user DB 312 to subtract the specified price points from the points of the viewer identified by the viewer ID included in the object specifying signal.

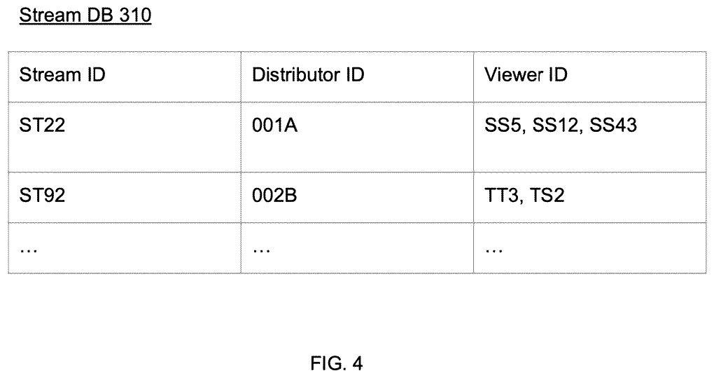

FIG. 4 is a data structure diagram of an example of the stream DB 310 of FIG. 3. The stream DB 310 holds information regarding a live stream currently taking place. The stream DB 310 stores the stream ID, the distributor ID, and the viewer ID, in association with each other. The stream ID is for identifying a live stream on a live streaming platform provided by the live streaming system 1. The distributor ID is a user ID for identifying the distributor who provides the live stream. The viewer ID is a user ID for identifying a viewer of the live stream. In the live streaming platform provided by the live streaming system 1 of some embodiments, when a user starts a live stream, the user becomes a distributor, and when the same user views a live stream broadcast by another user, the user also becomes a viewer. Therefore, the distinction between a distributor and a viewer is not fixed, and a user ID registered as a distributor ID at one time may be registered as a viewer ID at another time.

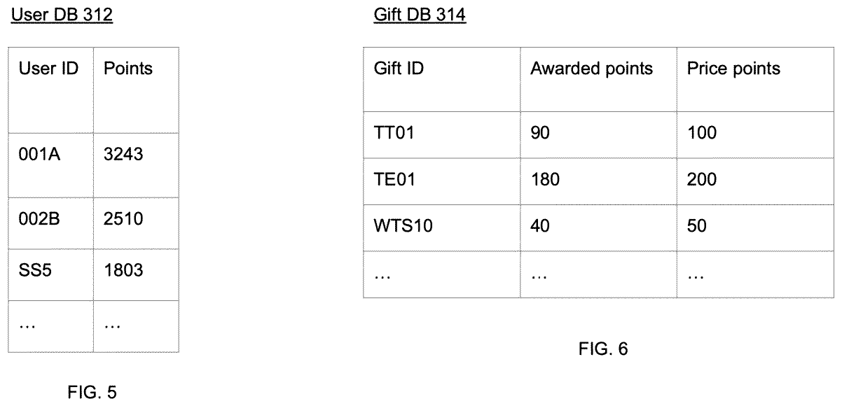

FIG. 5 is a data structure diagram showing an example of the user DB 312 of FIG. 3. The user DB 312 holds information regarding users. The user DB 312 stores the user ID and the point, in association with each other. The user ID identifies a user. The point corresponds to the points the corresponding user bolds. The point is the electronic value circulated within the live streaming platform. In some embodiments, when a distributor receives a gift from a viewer during a live stream, the distributor's points increase by the value corresponding to the gift. The points are used, for example, to determine the amount of reward (such as money) the distributor receives from the administrator of the live streaming platform. In some embodiments, when the distributor receives a gift from a viewer, the distributor may be given the amount of money corresponding to the gift instead of the points.

FIG. 6 is a data structure diagram showing an example of the gift DB 314 of FIG. 3. The gift DB 314 holds information regarding gifts available for the viewers in the live streaming. A gift is electronic data. A gift may be purchased with the points or money, or can be given for free. A gift may be given by a viewer to a distributor. Giving a gift to a distributor is also referred to as using, sending, or throwing the gift. Some gifts may be purchased and used at the same time, and some gifts may be purchased and then used at any time later by the purchaser viewer. When a viewer gives a gift to a distributor, the distributor is awarded the amount of points corresponding to the gift. When a gift is used, the use may trigger an effect associated with the gift. For example, an effect (such as visual or sound effect) corresponding to the gift will appear on the live streaming screen.

The gift DB 314 stores the gift ID, the awarded points, and the price points, in association with each other. The gift ID is for identifying a gift. The awarded points are the amount of points awarded to a distributor when the gift is given to the distributor. The price points are the amount of points to be paid for use (or purchase) of the gift. A viewer is able to give a desired gift to a distributor by paying the price points of the desired gift when the viewer is viewing the live stream. The payment of the price points may be made by an appropriate electronic payment means. For example, the payment may be made by the viewer paying the price points to the administrator. Alternatively, bank transfers or credit card payments may be used. The administrator is able to desirably set the relationship between the awarded points and the price points. For example, it may be set as the awarded points=the price points. Alternatively, points obtained by multiplying the awarded points by a predetermined coefficient such as 1.2 may be set as the price points, or points obtained by adding predetermined fee points to the awarded points may be set as the price points.

The interaction parameter DB 350 is configured to store interaction parameters of streams (live streams and/or archive streams) performed by distributors. The interaction parameters of a stream are related to viewers of the stream or viewer actions performed in the stream. The interaction parameters may include the number of comments, the number of received gifts, the number of received snacks, and the number of viewers. The interaction parameters may include temporal change (such as change rate or standardized rate) of the above parameters. For example, the interaction parameters may include the amount of gifts received per minute, increasing rate of received gift, or dropping rate of received gifts. The interaction parameters vary with time and may be stored in a time sequence form in the interaction parameter DB 350. In some embodiments, the interaction parameters could be received from a platform monitoring unit or a monitoring database within or outside the server 10.

The performance score calculator 330 is configured to generate/calculate performance scores for a stream (live stream and/or archive stream) according to the interaction parameters of the stream. The performance scores could be calculated in various ways according to the actual practice (or focus point) of the stream platform. In some embodiments, the performance score of a stream at timing T1 is calculated according to the interaction parameters of the stream at the timing T1. In some embodiments, the performance score could be equal to one interaction parameter. In some embodiments, the performance score could be a weighted sum of more than one interaction parameter. In some embodiments, the performance score could be proportional to one or more parameters. In some embodiments, the performance score increases as one or more interaction parameters increase. In some embodiments, the performance score decreases as one or more interaction parameters decrease. The performance score varies with time and may be stored in a time sequence form in the performance score DB 352.

In some embodiments, the performance score calculator 330 also generates a growing rate and/or a dropping rate of the performance score. For example, the performance score calculator 330 may generate an average performance score growing rate or an average performance score dropping rate within a time period.

The content tag DB 354 is configured to store content tags (or labels) of streams (live streams and/or archive streams). The content of a stream varies with time and the content tags may be stored in a time sequence form in the content tag DB 354. In some embodiments, the content tags could be received from a content detecting unit within or outside the server 10. The content detecting unit detects the content tags of a stream.

The stream analysis unit 332 is configured to analyze the performance of streams for the distributor. The stream analysis unit 332 may associate the performance scores (or change rate of the performance scores) of a stream with the content tags of the stream. The stream analysis unit 332 may calculate the correlation coefficients between the performance scores (or change rate of the performance scores) and the content tags. The analysis result is stored in the analysis result DB 356.

The stream analysis unit 332 is configured to determine (or detect) good and/or bad contents performed by the distributor in his/her streams. In some embodiments, the stream analysis unit 332 determines, according to a result of the associating process, a good content tag corresponding to a performance score higher than a good performance score threshold. In some embodiments, the stream analysis unit 332 determines, according to a result of the associating process, a bad content tag corresponding to a performance score lower than a bad performance score threshold. In some embodiments, the stream analysis unit 332 determines, according to a result of the associating process, a good content tag corresponding to a time period within which an average performance score growing rate is greater than a performance score growing rate threshold. In some embodiments, the stream analysis unit 332 determines, according to a result of the associating process, a bad content tag corresponding to a time period within which an average performance score dropping rate is greater than a performance score dropping rate threshold. The threshold values could be different for different distributors. For example, a higher level distributor may have a higher good performance score threshold.

The abnormality record DB 372 is configured to store the abnormality record of server 10. For example, crash records or latency records of various feature endpoints (such as endpoints for commenting, gifting, following) could be stored therein.

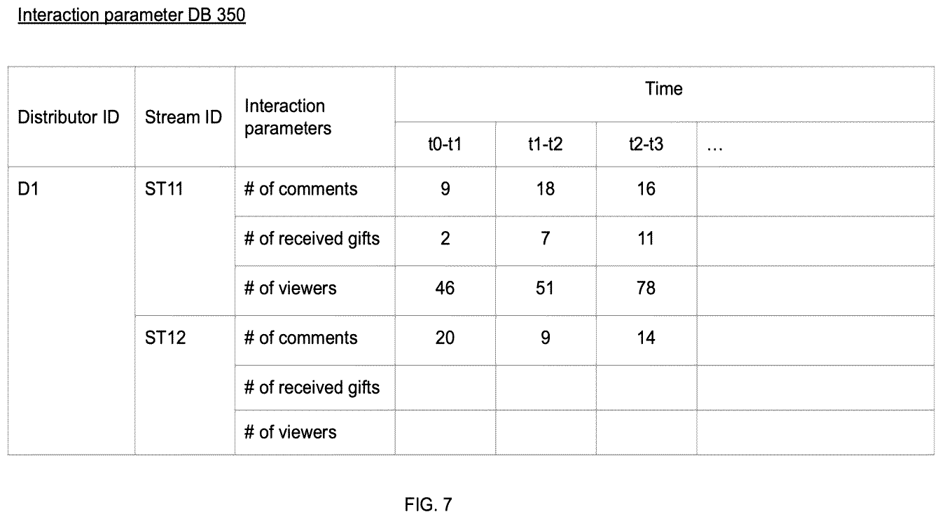

FIG. 7 is a data structure diagram of an example of the interaction parameter DB 350 of FIG. 3. The interaction parameter DB 350 holds information regarding archive streams performed by distributor D1. The interaction parameter DB 350 stores the distributor ID, the stream ID, the interaction parameters, and the time slots, in association with each other.

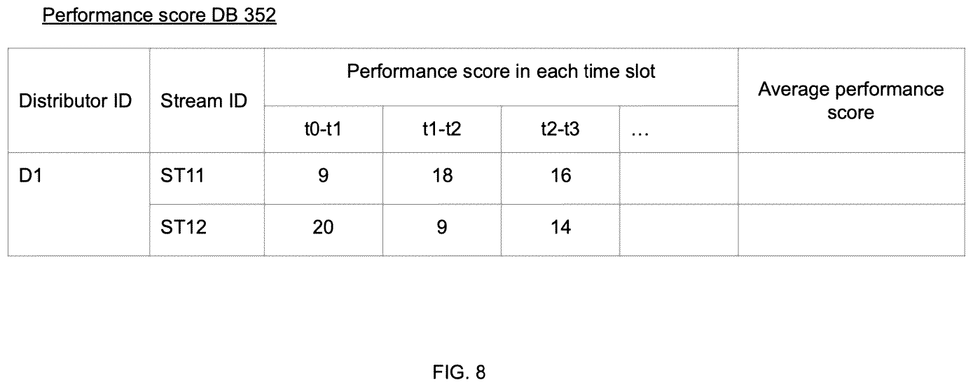

FIG. 8 is a data structure diagram of an example of the performance score DB 352 of FIG. 3. The performance score DB 352 stores the distributor ID, the stream ID, the performance score in each time slot, and the average performance score, in association with each other. In the embodiment shown in FIG. 7 and FIG. 8, the performance score is defined to be the number of comments. Therefore, the performance scores for each stream shown in FIG. 8 is equal to the number of comments shown in FIG. 7.

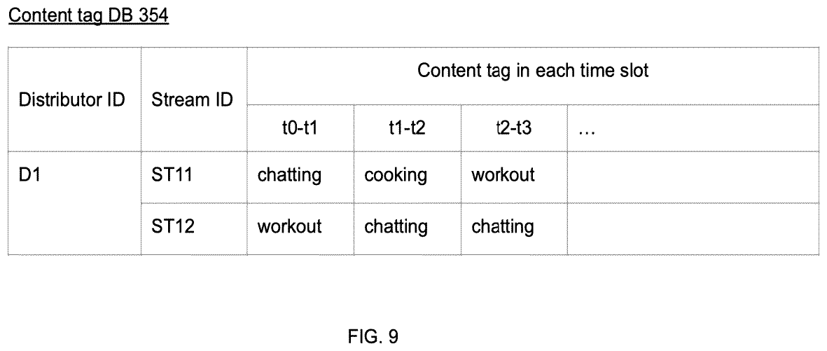

FIG. 9 is a data structure diagram of an example of the content tag DB 354 of FIG. 3. The content tag DB 354 stores the distributor ID, the stream ID, and the content tag in each time slot, in association with each other.

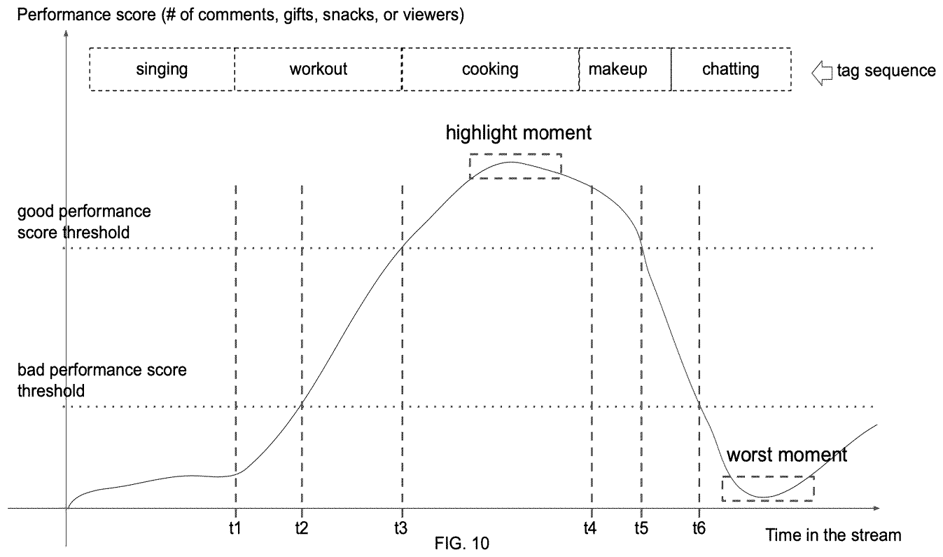

FIG. 10 shows an example of associating or correlating performance scores with content tags for a stream. In this embodiment, the performance score is the number of comments, gifts, snacks or viewers at each timing (or time slot). The tag sequence shows the detected content tags in different time spans.

Before timing t1, the performance score is lower than the bad performance score threshold. Therefore the corresponding content tag “singing” is determined to be a bad tag.

During timing t1 and timing t2, the performance score is still below the bad performance score threshold, however the performance score growing rate is greater than a performance score growing rate threshold. Therefore the corresponding content tag “workout” is determined to be a good tag in this embodiment. The determination by change rate can prevent the situation of mistakenly marking “workout” as bad content.

During timing t2 and timing t3, the performance score is between the bad performance score threshold and the good performance score threshold, and the performance score growing rate is greater than the performance score growing rate threshold. Therefore the corresponding content tag “workout” is determined to be a good content tag.

During timing t3 and timing t4, the performance score is greater than the good performance score threshold. Therefore the corresponding content tag “cooking” is determined to be a good content tag.

During timing t4 and timing t5, the performance score is still greater than the good performance score threshold, however the performance score dropping rate is greater than a performance score dropping rate threshold. Therefore the corresponding content tag “makeup” is determined to be a bad content tag in this embodiment. The determination by change rate can prevent the situation of mistakenly marking “makeup” as good content.

During timing t5 and timing t6, the performance score is between the bad performance score threshold and the good performance score threshold, and the performance score dropping rate is greater than the performance score dropping rate threshold. Therefore the corresponding content tags “makeup” and “chatting” are determined to be bad content tags.

After timing t6, the performance score is lower than the bad performance score threshold. Therefore the corresponding content tag “chatting” is determined to be a bad content tag.

As shown in FIG. 10, a highlight moment corresponding to the highest performance scores and a worst moment corresponding to the lowest performance scores can be determined (by the stream analysis unit 332, for example).

In some embodiments, change rate of performance score could be given a higher priority than the absolute value of performance score in determining good or bad content tags. The change rate of performance score may reflect the viewer engagement or the viewer satisfaction in a more precise and timely manner.

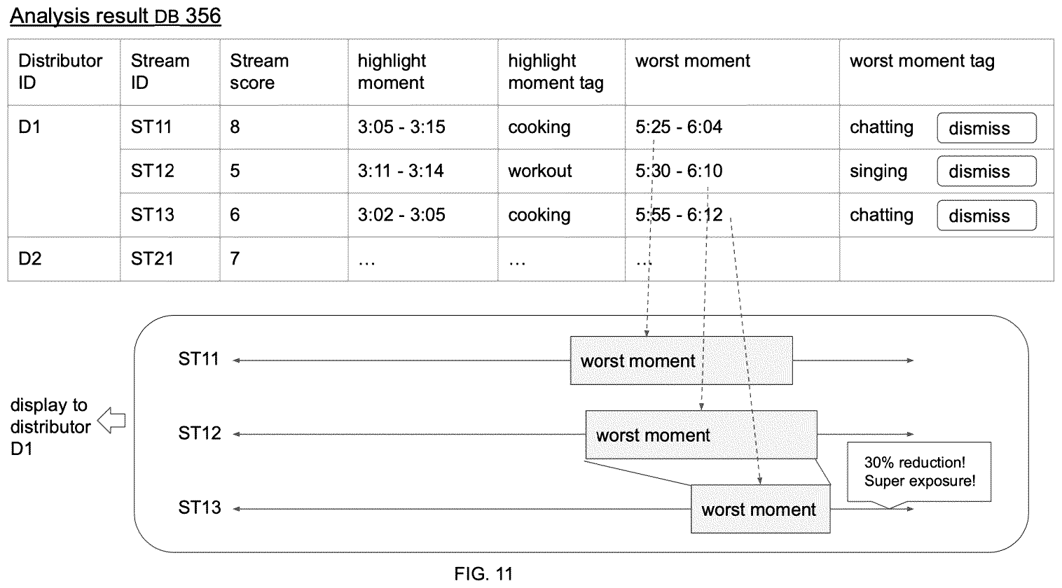

FIG. 11 shows a data structure diagram of an example of the analysis result DB 356 of FIG. 3. The analysis result DB 356 stores the distributor ID, the stream ID (or archive stream ID), the stream score, the highlight moment, the highlight moment tag, the worst moment, and the worst moment tag, in association with each other

The stream score could be the average performance score of the stream. The highlight moment could be the time span during which the performance score is the highest. The highlight moment tag is the content tag corresponding to the highlight moment. The worst moment could be the time span during which the performance score is the lowest. The worst moment tag is the content tag corresponding to the worst moment. Information within (or extracted from) the analysis result DB 356 could be displayed to the distributor, for example, whenever a new stream is finished.

As shown in FIG. 11, a summarized result of the analysis is displayed to the distributor D1. The result shows that the worst moment for the stream ST13 is 30% shorter than the streams S12 or S11. In some embodiments, the stream analysis unit 332 may display to the distributor (or may trigger a notification unit to send to the distributor) a message such as “Good job! You have reduced your worst moment by 30%, and have earned yourself a super exposure in the genre page!”.

In some embodiments, when the stream analysis unit 332 determines a later stream to have a shorter poor performance time period than a former stream, the stream analysis unit 332 increases a recommending priority for the distributor (and notifies the distributor). In some embodiments, when the stream analysis unit 332 determines a later stream to have a longer poor performance time period than a former stream, the stream analysis unit 332 decreases a recommending priority for the distributor (with notification) or sends a reminder message to the distributor. The poor performance time period corresponds to a performance score lower than a poor performance score threshold or corresponds to a performance score dropping rate greater than a performance score dropping rate threshold. The recommending priority corresponds to how likely the distributor will be seen by viewers on the streaming platform. For example, a higher recommending priority could mean a better slot place on the recommending page or a greater frequency of being displayed on the recommending page. The mechanism can encourage the distributor to improve his/her performance more seriously.

In some embodiments, in the page of the analysis result, the distributor can click on an object to replay a specific footage of his/her performance in an archive stream. For example, in the report shown in FIG. 11, distributor D1 may click on the “worst moment” area in ST11, ST12 or ST13 to trigger a replay of the corresponding stream data. A hyperlink to the stream data (or a portion of the stream data) could be utilized in the replay process. The replay mechanism can let the distributor to reflect on his/her performance (to know exactly what he/she was doing at that moment) and improve in an efficient manner.

In some embodiments, a feedback or correcting function could be provided to the distributor with respect to the analysis result. For example, distributor D1 checks the replay of the worst moment of the archive stream ST12, and determines that the reason for the content tag “singing” to be determined to be bad is accidental and shall not be counted. For example, the singing was performed by a friend of the distributor, or the distributor had a throat problem at that time. The distributor may click the “dismiss” button to remove the record, such that the tag “singing” will not be marked as a bad content tag.

In some embodiments, an automatic feedback or correcting process could be performed by the stream analysis unit 332 with respect to the analysis result. For example, the stream analysis unit 332 may access system abnormality records from the abnormality record DB 372. If an abnormality was found to have caused bias to the determination of a good or a bad tag, the determination may be dismissed. For example, if there was a crash for the gift endpoint during a time period, the determination of a bad content tag due to low gifts in that time period may be dismissed. The mechanism may ensure a more robust stream analysis.

In some embodiments, interaction parameters of an ongoing live stream are detected and stored into the interaction parameter DB 350 in a real time manner. The performance score calculator 330 calculates the performance scores for the live stream with its interaction parameters in a real time manner. The content tags of the live stream are detected and stored into the content tag DB 354 in a real time manner. The stream analysis unit 332 may provide real time feedback or suggestions to the distributor during the live streaming based on the content tags, the performance scores, and/or past analysis results.

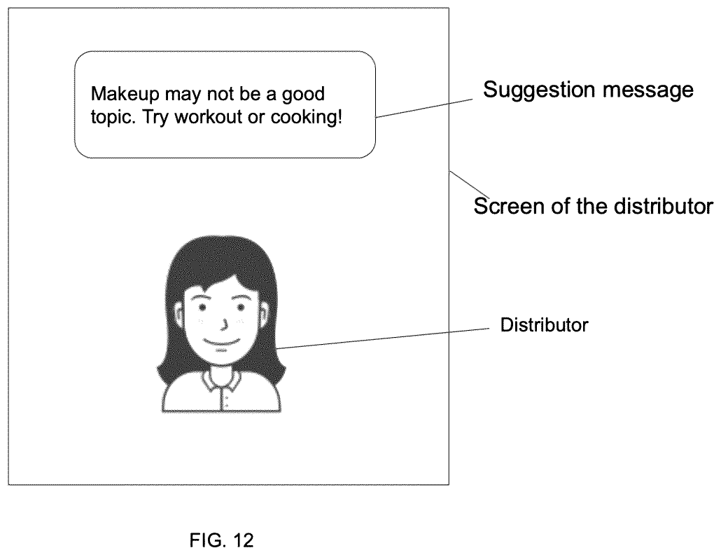

For example, the stream analysis unit 332 may have determined, according to archive streams analysis, a bad content tag (or a content tag that has been determined to be bad frequently) for a distributor. The bad content tag may correspond to a performance score lower than a bad performance score threshold or may correspond to a time period within which an average performance score dropping rate is greater than a performance score dropping rate threshold. Subsequently, the stream analysis unit 332 determines (or detects) the distributor to have started a new live stream. The stream analysis unit 332 may perform a constant matching (or comparison) process between the bad content tag and the newly detected tags of the live stream. When the stream analysis unit 332 determines (or detects), in a real time manner, a content of the live stream to have matched the bad content tag, the stream analysis unit 332 may suggest a content change to the distributor while the live stream is being distributed. The suggested content could be a good content tag determined from the archive stream analysis. An example of the suggestion during live streaming is shown in FIG. 12.

In some embodiments, before generating the performance scores, preprocesses could be done to remove the effect or bias from veteran contributors. A veteran contributor is a viewer who has been determined, by the server, to be willing to contribute to the distributor regardless of content topics performed by the distributor. For example, the performance score calculator 330 may determine a portion of the interaction parameters of a stream to have been contributed from veteran contributors (or regular fans) of the distributor. The performance score calculator 330 then removes that portion of interaction parameters when generating the performance scores for the stream. The mechanism could improve the accuracy of the performance analysis. In some embodiments, the interaction parameter DB 350 holds the information regarding who contributed to those interaction parameters. The information can be extracted from a monitoring unit within or outside the server 10.

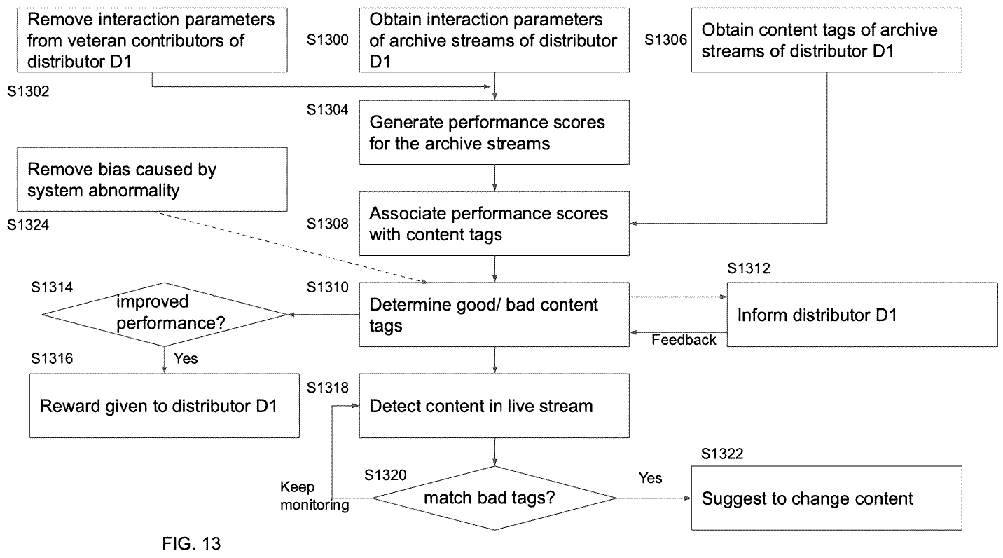

FIG. 13 shows an exemplary flow chart illustrating a method according to some embodiments of the present disclosure.

At step S1300, interaction parameters of archive streams of a distributor D1 are obtained by the server 10.

At step S1302, interaction parameters from veteran contributors of distributor D1 are removed by server 10 (or a filtering unit within server 10).

At step S1304, performance scores for the archive streams are generated by the performance score calculator 330, according to their interaction parameters.

At step S1306, content tags of those archive streams of distributor D1 are obtained by the server 10.

At step S1308, the performance scores are associated or correlated with the content tags by the stream analysis unit 332.

At step S1310, good and/or bad content tags are determined according to the association result (for example, according to the corresponding performance scores or the corresponding change rates of performance scores).

At step S1312, the analysis result is informed to distributor D1. Distributor D1 may perform a feedback or correction process to the analysis result.

At step S1314, the stream analysis unit 332 determines if a later stream has an improved performance than a former stream. An improved performance could be, for example, a longer time span for good content, a longer highlight moment, a shorter time span for bad content, or a shorter worst moment. If there is an improvement, the flow goes to step S1316.

At step S1316, a reward would be given to distributor D1. The reward could be, for example, a higher priority on the recommending page for subsequent streams (or live streams) of distributor D1.

At step S1318, the stream analysis unit 332 detects or monitors contents in a live stream newly started by distributor D1.

At step S1320, the stream analysis unit 332 determines, in a real time manner, if any content of the live stream matches a bad content tag. If yes, the flow goes to step S1332. Steps S1318 and S1320 are repeated to keep monitoring the contents of the live stream.

At step S1322, a content change is suggested to distributor D1.

In some embodiments, a step S1324 could be implemented. At step S1324, the stream analysis unit 332 refers to the interaction parameter DB 350, the performance score DB 352, the content tag DB 354, and the abnormality record DB 372 to remove the bias caused by system abnormality.

Referring to FIG. 3, the ML DB 370 may include various machine learning algorithms that could be utilized by the server 10 to analyze streams performances.

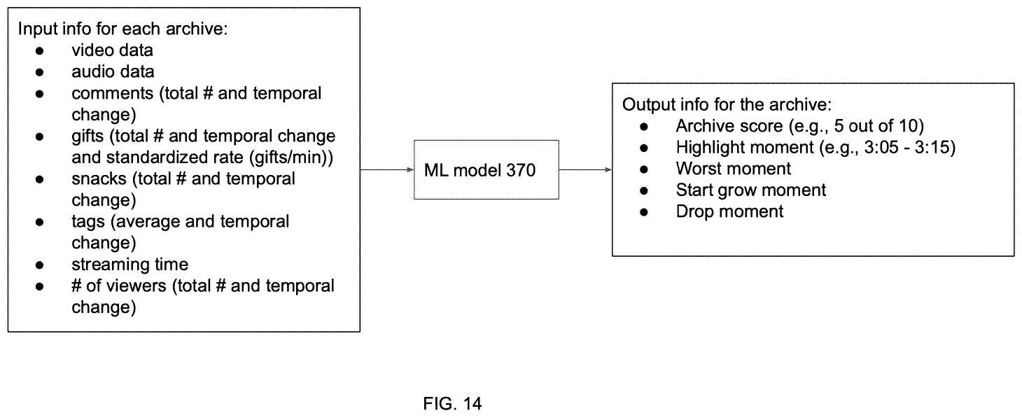

FIG. 14 shows an example of input and output of the ML model 370. The input data includes various information (or features) for each archive stream, such as video data, audio data, comments (total number and/or temporal change), gifts (total number, temporal change and/or standardized rate (gifts/min)), snacks (total number and/or temporal change), tags (average and/or temporal change), streaming time, and number of viewers (total number and/or temporal change). The out data includes the analysis result for the respect archive stream, such as archive score (e.g., 5 out of 10), highlight moment (e.g., 3:05-3:15), worst moment, start grow moment, and drop moment.

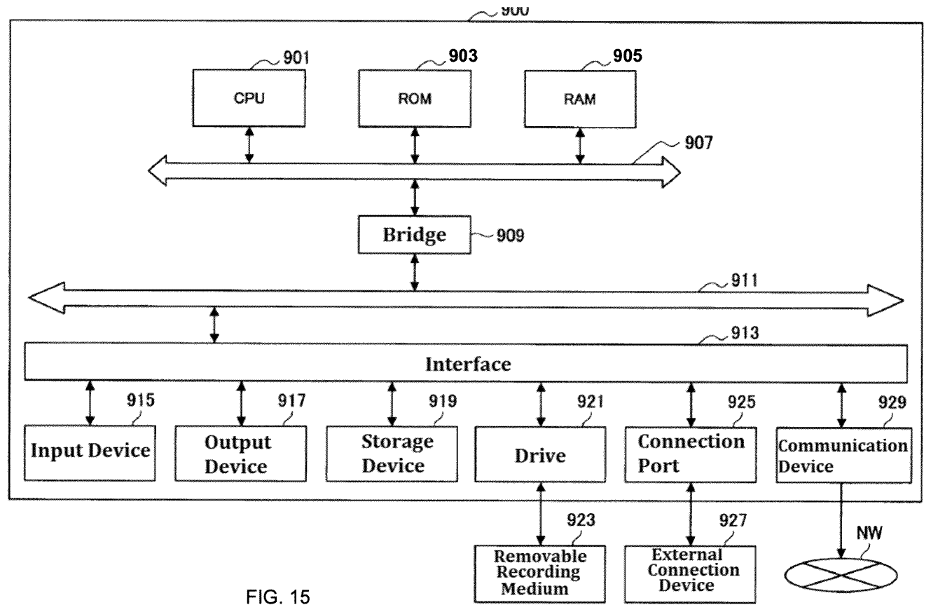

Referring to FIG. 15, the hardware configuration of the information processing device will be now described. FIG. 15 is a block diagram showing an example of a hardware configuration of the information processing device according to some embodiments of the present disclosure. The illustrated information processing device 900 may, for example, realize the server 10 and/or the user terminals 20 and 30 in some embodiments.

The information processing device 900 includes a CPU 901, ROM (Read Only Memory) 903, and RAM (Random Access Memory) 905. The information processing device 900 may also include a host bus 907, a bridge 909, an external bus 911, an interface 913, an input device 915, an output device 917, a storage device 919, a drive 921, a connection port 925, and a communication device 929. In addition, the information processing device 900 includes an image capturing device such as a camera (not shown). In addition to or instead of the CPU 901, the information processing device 900 may also include a DSP (Digital Signal Processor) or ASIC (Application Specific Integrated Circuit).

The CPU 901 functions as an arithmetic processing device and a control device, and controls all or some of the operations in the information processing device 900 according to various programs stored in the ROM 903, the RAM 905, the storage device 919, or the removable recording medium 923. For example, the CPU 901 controls the overall operation of each functional unit included in the server 10 and the user terminals 20 and 30 in some embodiments. The ROM 903 stores programs, calculation parameters, and the like used by the CPU 901. The RAM 905 serves as a primary storage that stores a program used in the execution of the CPU 901, parameters that appropriately change in the execution, and the like. The CPU 901, ROM 903, and RAM 905 are interconnected to each other by a host bus 907 which may be an internal bus such as a CPU bus. Further, the host bus 907 is connected to an external bus 911 such as a PCI (Peripheral Component Interconnect/Interface) bus via a bridge 909.

The input device 915 may be a user-operated device such as a mouse, keyboard, touch panel, buttons, switches and levers, or a device that converts a physical quantity into an electric signal such as a sound sensor typified by a microphone, an acceleration sensor, a tilt sensor, an infrared sensor, a depth sensor, a temperature sensor, a humidity sensor, and the like. The input device 915 may be, for example, a remote control device utilizing infrared rays or other radio waves, or an external connection device 927 such as a mobile phone compatible with the operation of the information processing device 900. The input device 915 includes an input control circuit that generates an input signal based on the information inputted by the user or the detected physical quantity and outputs the input signal to the CPU 901. By operating the input device 915, the user inputs various data and instructs operations to the information processing device 900.

The output device 917 is a device capable of visually or audibly informing the user of the obtained information. The output device 917 may be, for example, a display such as an LCD, PDP, or OLED, etc., a sound output device such as a speaker and headphones, and a printer. The output device 917 outputs the results of processing by the information processing unit 900 as text, video such as images, or sound such as audio.

The storage device 919 is a device for storing data configured as an example of a storage unit of the information processing equipment 900. The storage device 919 is, for example, a magnetic storage device such as a hard disk drive (HDD), a semiconductor storage device, an optical storage device, or an optical magnetic storage device. This storage device 919 stores programs executed by the CPU 901, various data, and various data obtained from external sources.

The drive 921 is a reader/writer for a removable recording medium 923 such as a magnetic disk, an optical disk, a photomagnetic disk, or a semiconductor memory, and is built in or externally attached to the information processing device 900. The drive 921 reads information recorded in the mounted removable recording medium 923 and outputs it to the RAM 905. Further, the drive 921 writes record in the attached removable recording medium 923.

The connection port 925 is a port for directly connecting a device to the information processing device 900. The connection port 925 may be, for example, a USB (Universal Serial Bus) port, an IEEE1394 port, an SCSI (Small Computer System Interface) port, or the like. Further, the connection port 925 may be an RS-232C port, an optical audio terminal, an HDMI (registered trademark) (High-Definition Multimedia Interface) port, or the like. By connecting the external connection device 927 to the connection port 925, various data can be exchanged between the information processing device 900 and the external connection device 927.

The communication device 929 is, for example, a communication interface formed of a communication device for connecting to the network NW. The communication device 929 may be, for example, a communication card for a wired or wireless LAN (Local Area Network), Bluetooth (trademark), or WUSB (Wireless USB). Further, the communication device 929 may be a router for optical communication, a router for ADSL (Asymmetric Digital Subscriber Line), a modem for various communications, or the like. The communication device 929 transmits and receives signals and the like over the Internet or to and from other communication devices using a predetermined protocol such as TCP/IP. The communication network NW connected to the communication device 929 is a network connected by wire or wirelessly, and is, for example, the Internet, home LAN, infrared communication, radio wave communication, satellite communication, or the like. The communication device 929 realizes a function as a communication unit.

The image capturing device (not shown) is an imaging element such as a CCD (Charge Coupled Device) or CMOS (Complementary Metal Oxide Semiconductor), and a device that captures an image of the real space using various elements such as lenses for controlling image formation of a subject on the imaging element to generate the captured image. The image capturing device may capture a still image or may capture a moving image.

The configuration and operation of the live streaming system 1 in the embodiment have been described. This embodiment is a mere example, and it is understood by those skilled in the art that various modifications are possible for each component and a combination of each process, and that such modifications are also within the scope of the present disclosure.

The processing and procedures described in the present disclosure may be realized by software, hardware, or any combination of these in addition to what was explicitly described. For example, the processing and procedures described in the specification may be realized by implementing a logic corresponding to the processing and procedures in a medium such as an integrated circuit, a volatile memory, a non-volatile memory, a non-transitory computer-readable medium and a magnetic disk. Further, the processing and procedures described in the specification can be implemented as a computer program corresponding to the processing and procedures, and can be executed by various kinds of computers.

Furthermore, the system or method described in the above embodiments may be integrated into programs stored in a computer-readable non-transitory medium such as a solid state memory device, an optical disk storage device, or a magnetic disk storage device. Alternatively, the programs may be downloaded from a server via the Internet and be executed by processors.

Although technical content and features of the present disclosure are described above, a person having common knowledge in the technical field of the present disclosure may still make many variations and modifications without disobeying the teaching and disclosure of the present disclosure. Therefore, the scope of the present disclosure is not limited to the embodiments that are already disclosed, but includes another variation and modification that do not disobey the present disclosure, and is the scope covered by the patent application scope.

### LIST OF REFERENCE NUMBERS

1 communication system
10 server
20 user terminal
30, 30a, 30b user terminal
LV distributor
AU1, AU2 viewer
VD, VD1, VD2 video image
NW network
30 user terminal
100 distribution unit
102 image capturing control unit
104 audio control unit
106 video transmission unit
108 distributor-side UI control unit
200 viewing unit
202 viewer-side UI control unit
204 superimposed information generation unit
206 input information transmission unit
302 distribution information providing unit
304 relay unit
306 gift processing unit
308 payment processing unit
310 stream DB
312 user DB
314 gift DB
330 performance score calculator
332 stream analysis unit
350 interaction parameter DB
352 performance score DB
354 content tag DB
356 analysis result DB
370 ML DB
372 abnormality record DB
S1300, S1302, S1304, S1306, S1308, S1310, S1312, S1314, S1316, S1318,
S1320, S1322, S1324 step
900 information processing device
901 CPU
903 ROM
905 RAM
907 host bus
909 bridge
911 external bus
913 interface
915 input device
917 output device
919 storage device
921 drive
923 removable recording medium
925 connection port
927 external connection device
929 communication device

What is claimed is:

1. A method for stream analysis, executed by a server, comprising:
obtaining a first set of interaction parameters of a first stream performed by a distributor;
generating a first set of performance scores for the first stream according to the first set of interaction parameters;
obtaining a first set of content tags of the first stream; and
associating the first set of performance scores with the first set of content tags.

2. The method according to claim 1, further comprising:
determining, according to a result of the associating process, a good content tag corresponding to a performance score higher than a good performance score threshold.

3. The method according to claim 1, further comprising:
determining, according to a result of the associating process, a good content tag corresponding to a time period within which an average performance score growing rate is greater than a performance score growing rate threshold.

4. The method according to claim 1, further comprising:
determining, according to a result of the associating process, a bad content tag corresponding to a performance score lower than a bad performance score threshold.

5. The method according to claim 1, further comprising:
determining, according to a result of the associating process, a bad content tag corresponding to a time period within which an average performance score dropping rate is greater than a performance score dropping rate threshold.

6. The method according to claim 1, wherein the generating the first set of performance scores for the first stream according to the first set of interaction parameters further comprises:
determining a portion of the first set of interaction parameters to have been contributed from veteran contributors of the distributor; and
removing the portion of interaction parameters from the first set of interaction parameters when generating the first set of performance scores for the first stream,
wherein the veteran contributors have been determined, by the server, to be willing to contribute to the distributor regardless of content topics performed by the distributor.

7. The method according to claim 1, further comprising:
determining, according to a result of the associating process, a bad content tag corresponding to a performance score lower than a bad performance score threshold or corresponding to a time period within which an average performance score dropping rate is greater than a performance score dropping rate threshold;
determining the distributor to have started a new live streaming;
determining, in a real time manner, a content of the new live streaming to have matched the bad content tag; and
suggesting a content change to the distributor while the new live streaming is being distributed.

8. The method according to claim 1, further comprising:
displaying a result of the associating process to the distributor,
wherein the result includes a good content tag or a bad content tag.

9. A method for stream analysis, executed by a server, comprising:
obtaining a first set of interaction parameters of a first stream performed by a distributor;
generating a first set of performance scores for the first stream according to the first set of interaction parameters;
obtaining a second set of interaction parameters of a second stream performed by the distributor;
generating a second set of performance scores for the second stream according to the second set of interaction parameters;
determining the second stream to have a shorter poor performance time period than the first stream; and
increasing a recommending priority for the distributor,
wherein the poor performance time period corresponds to a performance score lower than a poor performance score threshold or corresponds to a performance score dropping rate greater than a performance score dropping rate threshold.

10. A system for stream analysis, comprising one or a plurality of processors, wherein the one or plurality of processors execute a machine-readable instruction to perform:
obtaining a first set of interaction parameters of a first stream performed by a distributor;
generating a first set of performance scores for the first stream according to the first set of interaction parameters;
obtaining a first set of content tags of the first stream; and
associating the first set of performance scores with the first set of content tags.
